(19) United States
(12) Patent Application Publication
(10) Pub. No.: US 2009/0295703 A1
(43) Pub. Date: Dec. 3, 2009

(54) LIQUID CRYSTAL DISPLAY PANEL AND DRIVING METHOD THEREOF

(75) Inventors: Ming-Feng HSIEH, Tainan County (TW); Yu-Yeh CHEN, Tainan County (TW); Han-Chung HUANG, Tainan County (TW); Yi-Fen CHUANG, Tainan County (TW); Chih-Yung HSIEH, Tainan County (TW)

Correspondence Address: LOWE HAUPTMAN HAM & BERNER, LLP, 1700 DIAGONAL ROAD, SUITE 300, ALEXANDRIA, VA, 22314, US

(73) Assignee: CHI MEI OPTOELECTRONICS CORP., Tainan County (TW)

(21) Appl. No.: 12/407,972

(22) Filed: Mar. 20, 2009

(30) Foreign Application Priority Data
May 30, 2008 (TW) 97120266

(51) Int. Cl. G09G 3/36

(52) U.S. Cl. 345/94; 345/98

(57) ABSTRACT

A liquid crystal display panel includes a plurality of pixels and each of the pixels includes a first sub-pixel and a second sub-pixel. The first sub-pixel and the second sub-pixel individually load a source voltage according to a first gate pulse and a second gate pulse, respectively. The second sub-pixel includes a first storage capacitor and a first compensation capacitor. The first compensation capacitor charges or discharges to a predetermined voltage before performing charge neutralization with the first storage capacitor according to a second gate pulse.

This application claims the benefit of Taiwan application Serial No. 97120266, filed May 30, 2008, the entire disclosure of which is incorporated herein by reference.

### BACKGROUND

The disclosure relates to a liquid crystal display panel and a method of driving such panel which in one or more embodiments are capable of eliminating residual images and/or non-uniform images.

A multi-domain vertical alignment liquid crystal display (MVA-_{LC}D) is capable of satisfying the requirement of wide viewing angle because the alignment protrusions or slits formed on the color filter substrate or the display device array substrate can cause liquid crystal molecules to be arranged in multiple directions to form multiple different alignment domains. However, it is inevitable that the transmittance-level curve of the MVA-LCD has different curvatures when the viewing angles are changed. The brightness displayed by the MVA-LCD varies as the viewing angle alters, which leads to the problems such as color shift, color washout, and so forth. At present, a structure as described below has been provided to solve the problems of color shift and color washout.

FIG. 1 is a circuit diagram of a pixel known to the inventor(s). Referring to FIG. 1, a pixel 100 includes a first sub-pixel 110 and a second sub-pixel 120. In the first sub-pixel 110, a switch SW₁₃ is conducted (turned-on) according to a gate pulse transmitted via a scan line SL₁₁. A source voltage VS₁₁ transmitted via a data line DL₁₁ is stored in a storage capacitor C_{ST11} and a liquid crystal capacitor C_{LC11}. In the meantime, a switch SW₁₁ is also conducted, and the source voltage VS₁₁ is stored in a storage capacitor C_{ST12} and a liquid crystal capacitor C_{LC12} of the second sub-pixel 120.

After the first sub-pixel 110 and the second sub-pixel 120 store the source voltage VS₁₁, a switch SW₁₂ is conducted according to a gate pulse transmitted via a scan line SL₁₂. Further, the charges in the liquid crystal capacitor C_{LC12}, the storage capacitor C_{ST12}, and a compensation capacitor C_{CN1} are neutralized. Accordingly, the pixel 100 mixes colors of the sub-pixels based on different transmittance variations of the two sub-pixels 110 and 120, so as to equate the transmittance variations at a side viewing angle and at a front viewing angle, and thereby solving the problems of color shift and color washout.

In the known technology, however, the charge in the compensation capacitor C_{CN1} is varied whenever the compensation capacitor C_{CN1} performs the charge neutralization. In other words, the quantum of charge in the compensation capacitor C_{CN1} changes as the pixel 100 switches the gray scale of the displayed image. Under such a circumstance, the pixel 100 cannot predict the charge in the compensation capacitor C_{CN1}. When the pixel 100 displays an image, gray scale voltage levels may be inconsistent and result in the problems of residual image and non-uniform image.

### BRIEF DESCRIPTION OF THE DRAWINGS

FIG. 1 is a circuit diagram of a known pixel.

FIG. 2A is a circuit diagram of a pixel according to an embodiment.

FIG. 2B is a waveform-timing diagram for illustrating the operation of the embodiment of FIG. 2A.

FIG. 3A is a circuit diagram of a pixel according to another embodiment.

FIG. 3B is a waveform-timing diagram for illustrating the operation of the embodiment of FIG. 3A.

FIG. 4A is a circuit diagram of a pixel according to a further embodiment.

FIG. 4B is a waveform-timing diagram for illustrating the operation of the embodiment of FIG. 4A.

FIG. 5A is a circuit diagram of a pixel according to still another embodiment.

FIG. 5B is a waveform-timing diagram for illustrating the operation of the embodiment of FIG. 5A.

FIG. 6A is a circuit diagram of a pixel according to yet another embodiment.

FIG. 6B is a waveform-timing diagram for illustrating the operation of the embodiment of FIG. 6A.

FIG. 7A is a circuit diagram of a pixel according to a still further embodiment.

FIG. 7B is a waveform-timing diagram for illustrating the operation of the embodiment of FIG. 7A.

FIG. 8 is a flowchart illustrating a driving method of a liquid crystal display panel according to an embodiment.

FIG. 9 is a flowchart illustrating a driving method of a liquid crystal display panel according to another embodiment.

### DETAILED DESCRIPTION OF EMBODIMENTS

In the following detailed description, for purposes of explanation, numerous specific details are set forth in order to provide a thorough understanding. It will be apparent, however, that further embodiments may be practiced without these specific details. In other instances, well-known structures and devices are schematically shown in order to simplify the drawings.

In addition, the liquid crystal display panels in the embodiments comprise a plurality of pixels. For clarity and simplicity, only one of the pixels is illustrated as an example for explanation. In the following paragraphs, elements having identical or similar functions and structures are assigned with the same reference numbers and terms for consistency.

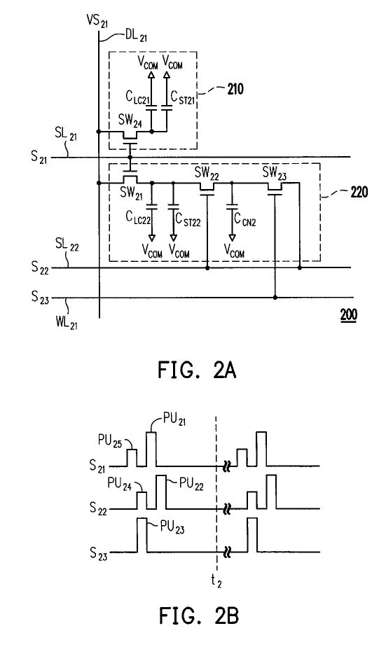

FIG. 2A is a circuit diagram of a pixel according to an embodiment. With reference to FIG. 2A, a pixel 200 includes a first sub-pixel 210 and a second sub-pixel 220. Herein, the first sub-pixel 210 is coupled to a data line DL₂₁ and a scan line SL₂₁. The second sub-pixel 220 is coupled to the data line DL₂₁, the scan line SL₂₁, a scan line SL₂₂, and a level switching line WL₂₁. In this embodiment, the scan line SL₂₂ and a scan line SL₂₃ are respectively connected to structures identical to the first sub-pixel 210 and the second sub-pixel 220 as well. For simplicity, these structures are not shown in the drawings.

Furthermore, the first sub-pixel 210 comprises a switch SW₂₄, a storage capacitor C_{ST21}, and a liquid crystal capacitor C_{LC21}. Herein, a first end of the switch SW₂₄, such as a drain, is coupled to the data line DL₂₁, and a control end of the switch SW₂₄, such as a gate, is coupled to the scan line SL₂₁. A first end of the liquid crystal capacitor C_{LC21} is coupled to a second end, such as a source, of the switch SW₂₄, and a second end of the liquid crystal capacitor C_{LC21} is coupled to a common voltage V_{COM}. The storage capacitor C_{ST21} and the liquid crystal capacitor C_{LC21} are connected in parallel.

Moreover, the second sub-pixel 220 comprises a switch SW₂₁, a switch SW₂₂, a switch SW₂₃, a storage capacitor C_{ST22}, a compensation capacitor C_{CN2}, and a liquid crystal capacitor C_{LC22}. A first end of the switch SW₂₁, such as a drain, is coupled to the data line DL₂₁, and a control end of the switch SW₂₁, such as a gate, is coupled to the scan line SL₂₁. A first end of the liquid crystal capacitor C_{LC22} is coupled to a second end, such as a source, of the switch SW₂₁, and a second end of the liquid crystal capacitor C_{LC22} is coupled to the common voltage V_{COM}. The storage capacitor C_{ST22} and the liquid crystal capacitor C_{LC22} are connected in parallel. Additionally, a first end of the switch SW₂₂ is coupled to a first end of the storage capacitor C_{ST22}, and a control end of the switch SW₂₂ is coupled to the scan line SL₂₂. A first end of the compensation capacitor C_{CN2} is coupled to a second end of the switch SW₂₂, and a second end of the compensation capacitor C_{CN2} is coupled to the common voltage V_{com}. A first end of the switch SW₂₃ is coupled to the first end of the compensation capacitor C_{CN2}, and a control end of the switch SW₂₃ is coupled to the level switching line WL₂₁. Further, a second end of the switch SW₂₃ is coupled to the scan line SL₂₂.

FIG. 2B is a waveform-timing diagram for illustrating the operation of the embodiment of FIG. 2A. wherein S₂₁ represents a signal transmitted via the scan line SL₂₁, S₂₂ represents a signal transmitted via the scan line SL₂₂, S₂₃ represents a signal transmitted via the level switching line WL₂₁, and VS₂₁ represents a source voltage transmitted via the data line DL₂₁. The signal S₂₁ comprises a gate pulse PU₂₁ and a specific pulse PU₂₅ as time changes. Similarly, the signal S₂₂ comprises a gate pulse PU₂₂ and a specific pulse PU₂₄, and the signal S₂₃ comprises a switching pulse PU₂₃. In this embodiment, the specific pulse PU₂₅ is equal to the specific pulse PU₂₄, and the gate pulse PU₂₁ is equal to the gate pulse PU₂₂.

The specific pulse PU₂₅ is transmitted to another pixel (not shown) of the scan line SL₂₁, and the operation mechanism thereof is the same as the operation mechanism of the specific pulse PU₂₄ and the pixel 200. Furthermore, in this specific embodiment, the switching pulse PU₂₃, the gate pulse PU₂₁, and the gate pulse PU₂₂ are transmitted sequentially, and the specific pulse PU₂₄ and the switching pulse PU₂₃ are transmitted simultaneously.

Further, referring to FIG. 2A and FIG. 2B for the operation mechanism of the pixel 200, the switch SW₂₄ conducts the first end and the second end thereof according to the gate pulse PU₂₁. In the meantime, the data line DL₂₁ and the storage capacitor Cs₅₁ are electrically connected, so as to load the source voltage VS₂₁ on the data line DL₂₁ to the liquid crystal capacitor C_{LC21}. Because the liquid crystal capacitor C_{LC21} and the storage capacitor C_{ST21} are connected in parallel, the source voltage VS₂₁ is stored in the storage capacitor C_{ST21} as well. Meanwhile, the switch SW₂₁ also conducts the first end and the second end thereof according to the gate pulse PU₂₁. The source voltage VS₂₁ is loaded to the liquid crystal capacitor C_{LC22} and the storage capacitor C_{ST22}.

Then, the switch SW₂₂ conducts the first end and the second end thereof according to the gate pulse PU₂₂. At the same time, the charges in the liquid crystal capacitor C_{LC22}, the storage capacitor C_{ST22}, and the compensation capacitor C_{CN2} are neutralized. Thereby, the transmittance variations of the first sub-pixel 210 and the second sub-pixel 220 are differentiated. The pixel 200 mixes colors and/or gray levels of the sub pixels based on the different transmittance variations of the two sub-pixels and brings the transmittance at a side viewing angle close to that at a front viewing angle to overcome the problems of color shift and color washout.

It should be noted that the switch SW₂₃ conducts the first end and the second end thereof according to the switching pulse PU₂₃ before the compensation capacitor C_{CN2} performs charge neutralization. Simultaneously, the compensation capacitor C_{CN2} loads the specific pulse PU₂₄ transmitted via the scan line SL₂₂. Because a voltage level of the specific pulse PU₂₄ is maintained at a predetermined voltage, the compensation capacitor C_{CN2} is charged or discharged to the predetermined voltage correspondingly.

In other words, before the liquid crystal capacitor C_{LC22}, the storage capacitor C_{ST22}, and the compensation capacitor C_{CN2} perform charge neutralization, the compensation capacitor C_{CN2} charges or discharges to the predetermined voltage according to the switching pulse PU₂₃. Assume that the pixel 200 starts gray scale switching of the image at a timing t₂, then during the switching, the compensation capacitor C_{CN2} is still charging or discharging to the predetermined voltage based on the aforementioned waveform and then performs charge neutralization with the liquid crystal capacitor C_{LC22} and the storage capacitor C_{ST22}.

No matter how many times the pixel 200 switches the gray scale of the image, the quantum of charge in the compensation capacitor C_{CN2} remains a fixed value before charge neutralization is performed. The problems of residual image and non-uniform image, resulting from the uncertain charge of the compensation capacitor, are therefore overcome. It is noted that the predetermined voltage as described in this embodiment may be the common voltage V_{COM}. In other embodiments the predetermined voltage is varied to meet certain designs and requirements.

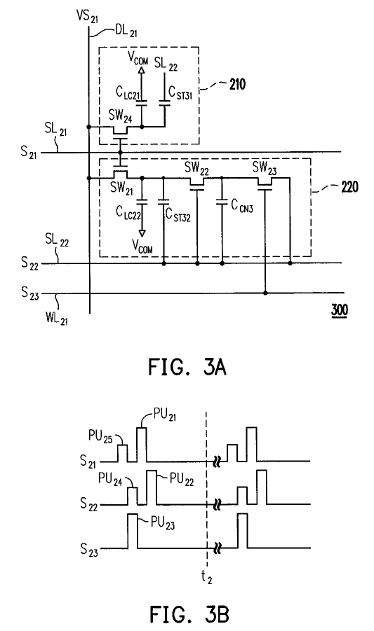

FIG. 3A is a circuit diagram of a pixel 300 according to another embodiment, and FIG. 3B is a waveform-timing diagram for illustrating the operation of the embodiment of FIG. 3A. A storage capacitor C_{ST31} of the first sub-pixel 210 and a compensation capacitor C_{CN3} and a storage capacitor C_{ST32} of the second sub-pixel 220 differentiate the embodiments of FIGS. 3A and 3B from the embodiments of FIGS. 2A and 2B.

To be more specific, in the pixel 300, a first end of the storage capacitor C_{ST31} is coupled to the second end of the switch SW₂₄, and a second end of the storage capacitor C_{ST31} is coupled to the scan line SL₂₂. In addition, a first end of the compensation capacitor C_{CN3} is coupled to the second end of the switch SW₂₂, and a second end of the compensation capacitor C_{CN3} is coupled to the scan line SL₂₂. Further, a first end of the storage capacitor C_{ST32} is coupled to the second end of the switch SW₂₁, and a second end of the storage capacitor C_{ST32} is coupled to the scan line SL₂₂. In this embodiment, the storage capacitors C_{ST31} and C_{ST32} and the compensation capacitor C_{CN3} share the scan line SL₂₂, so as to simplify the complexity of the wire layout in the pixel 300.

Similar to the embodiment shown in FIG. 2A, the switch SW₂₃ conducts the first end and the second end thereof according to the switching pulse PU₂₃ before the liquid crystal capacitor C_{LC22}, the storage capacitor C_{ST32}, and the compensation capacitor C_{CN3} performs the charge neutralization. In the meantime, the compensation capacitor C_{CN3} loads a specific pulse PU₂₄ which has a voltage level maintained at the predetermined voltage. In other words, the quantum of charge in the compensation capacitor C_{CN3} is maintained at a fixed value before neutralization is performed, so as to solve the problems of residual image and non-uniform image caused by the changeable charge of the compensation capacitor.

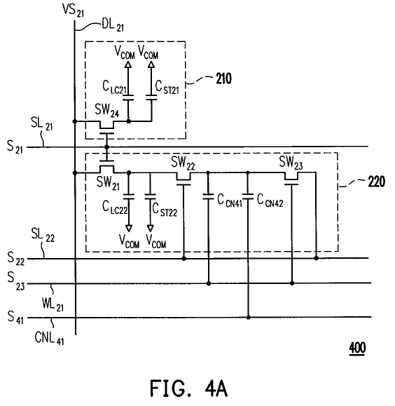

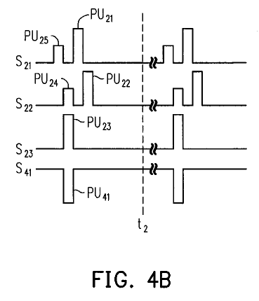

Further, FIG. 4A is a circuit diagram of a pixel 400 according to another embodiment, and FIG. 4B is a waveform-timing diagram for illustrating the operation of the embodiment of FIG. 4A.

Compensation capacitors C_{CN41} and C_{CN42} and a level complementary line CNL₄₁ of the second sub-pixel 220 are the main differences between the embodiments of FIGS. 4A and 4B and the foregoing embodiments.

Specifically, in the pixel 400, a first end of the compensation capacitor C_{CN41} is coupled to the second end of the switch SW₂₂, and a second end of the compensation capacitor C_{CN41} is coupled to the level switching line WL₂₁. A first end of the compensation capacitor C_{CN42} is coupled to the first end of the compensation capacitor C_{CN41}, and a second end of the compensation capacitor C_{CN42} is coupled to the level complementary line CNL₄₁. As shown in FIG. 4B, S₄₁ represents a signal transmitted via the level complementary line CNL₄₁, and a voltage level of the signal S₄₁ forms a complementary pulse PU₄₁ as time changes. It should be noted that the complementary pulse PU₄₁ is reverse to the switching pulse PU₂₃. Therefore, the complementary pulse PU₄₁ loaded to the compensation capacitor C_{CN42} may compensate the capacitor coupling effects which the switching pulse PU₂₃ causes to the compensation capacitor C_{CN41}.

In this embodiment, it should also be noted that the second end of the storage capacitor C_{ST21} may also be electrically connected to the level switching line WL₂₁ or the level complementary line CNL₄₁ in addition to the common voltage V_{COM}. Further, the level switching line WL₂₁ and the level complementary line CNL₄₁ transmit the switching pulse PU₂₃ and the complementary pulse PU₄₁ before the gate pulse PU₂₁ is formed. In addition, when the gate pulse PU₂₁ is formed, the signals S₂₃ and S₄₁ transmitted via the level switching line WL₂₁ and the level complementary line CNL₄₁, respectively, will be restored to the common voltage V_{COM}. Hence, when the gate pulse PU₂₁ is formed, the storage capacitor C_{ST21} loads the source voltage VS₂₁ based on the common voltage V_{COM} notwithstanding whether the second end of the storage capacitor C_{ST21} is electrically connected to the level switching line WL₂₁ or to the level complementary line CNL₄₁.

Similar to the above embodiments, the compensation capacitors C_{CN41} and C_{CN42} perform charge neutralization with the liquid crystal capacitor C_{LC22} and the storage capacitor C_{ST22}. Before performing the charge neutralization, the compensation capacitors C_{CN41} and C_{CN42} load the specific pulse PU₂₄ which has voltage level maintained at the predetermined voltage. Accordingly, the pixel 400 is able to solve the problems of residual image and non-uniform image, resulting from the changeable charge of the compensation capacitor.

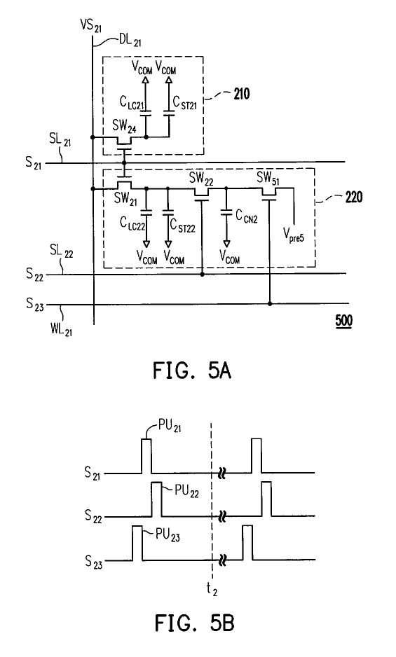

FIG. 5A is a circuit diagram of a pixel 500 according to another embodiment, and FIG. 5B is a waveform-timing diagram for illustrating the operation of the embodiment of FIG. 5A.

A switch SW₅₁ of the second sub-pixel 220 differentiates the embodiments of FIG. 5A and FIG. 5B from the foregoing embodiments.

Specifically, in the pixel 500, a first end of the switch SW₅₁ is coupled to the first end of the compensation capacitor C_{CN2}, and a second end of the switch SW₅₁ is coupled to a predetermined voltage Vₚᵣₑ₅. Furthermore, a control end of the switch SW₅₁ is coupled to the level switching line WL₂₁. Herein, the switch SW₅₁ conducts the first end and the second end thereof according to the switching pulse PU₂₃, so as to charge or discharge the compensation capacitor C_{CN2} to the predetermined voltage Vₚᵣₑ₅. Thereby, the quantum of charge of the compensation capacitor C_{CN2} is maintained at a fixed value before charge neutralization is performed.

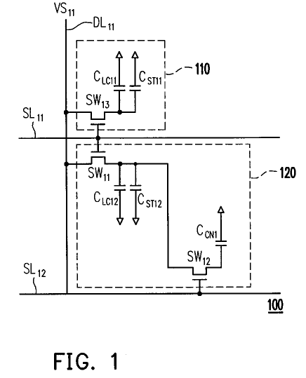

It is noted that, because the second end of the switch SW₅₁ is directly coupled to a constant voltage source (the predetermined voltage Vₚᵣₑ₅) as shown in FIG. 5B, each of the signals S₂₁ and S₂₂ transmitted via the scan lines SL₂₁ and SL₂₂ merely comprises one gate pulse. That is to say, the pixel 500 may adopt a driving waveform similar to the pixel 100 (shown in FIG. 1) for displaying images. In addition, similar to the above embodiments, the compensation capacitor C_{CN2} charges or discharges to the predetermined voltage according to the switching pulse PU₂₃ before performing charge neutralization. Therefore, the pixel 500 is able to solve the problems of residual image and non-uniform image which results from the changeable charge of the compensation capacitor.

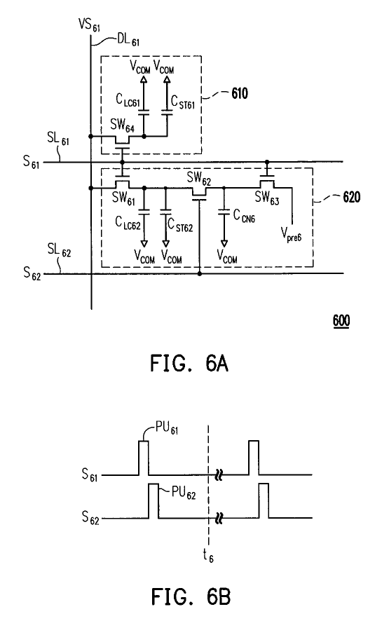

FIG. 6A is a circuit diagram of a pixel 600 according to yet another embodiment. Referring to FIG. 6A, the pixel 600 comprises a first sub-pixel 610 and a second sub-pixel 620. Herein, the first sub-pixel 610 is coupled to a data line DL₆₁ and a scan line SL₆₁. The second sub-pixel 620 is coupled to the data line DL₆₁ and scan lines SL₆₁˜SL₆₂.

Further, the first sub-pixel 610 comprises a switch SW₆₄, a storage capacitor C_{ST61}, and a liquid crystal capacitor C_{LC61}. Herein, a first end of the switch SW₆₄ is coupled to the data line DL₆₁ and a control end of the switch SW₆₄ is coupled to the scan line SL₆₁. A first end of the liquid crystal capacitor C_{LC61} is coupled to the second end of the switch SW₆₄, and a second end of the liquid crystal capacitor C_{LC61} is coupled to the common voltage V_{COM}. The storage capacitor C_{ST61} and the liquid crystal capacitor C_{LC61} are connected in parallel.

In addition, the second sub-pixel 620 comprises switches SW₆₁˜SW₆₃, a storage capacitor C_{ST62}, a compensation capacitor C_{CN}6, and a liquid crystal capacitor C_{LC62}. Herein, a first end of the switch SW₆₁ is coupled to the data line DL₆₁ and a control end of the switch SW₆₁ is coupled to the scan line SL₆₁. A first end of the liquid crystal capacitor C_{LC62} is coupled to a second end of the switch SW₆₁, and a second end of the liquid crystal capacitor C_{LC62} is coupled to the common voltage V_{COM}. The storage capacitor C_{ST62} and the liquid crystal capacitor C_{LC62} are connected in parallel.

Moreover, a first end of the switch SW₆₂ is coupled to a first end of the storage capacitor C_{ST62}, and a control end of the switch SW₆₂ is coupled to the scan line SL₆₂. A first end of the compensation capacitor C_{CN6} is coupled to a second end of the switch SW₆₂, and a second end of the compensation capacitor C_{CN6} is coupled to the common voltage V_{COM}. A first end of the switch SW₆₃ is coupled to the first end of the compensation capacitor C_{CN6}, and a control end of the switch SW₆₃ is coupled to the scan line SL₆₁. Further, a second end of the switch SW₆₃ is coupled to a predetermined voltage Vₚᵣₑ₆. It should be noted that the predetermined voltage Vₚᵣₑ₆ as described in this embodiment may be the common voltage V_{COM}. However, in other embodiments, the predetermined voltage is varied to meet certain designs and requirements.

FIG. 6B is a waveform-timing diagram for illustrating the operation of the fifth embodiment, wherein S₆₁ represents a signal transmitted via the scan line SL₆₁, S₆₂ represents a signal transmitted via the scan line SL₆₂, and VS₆₁ represents a source voltage transmitted via the data line DL₆₁. In addition, a voltage level of the signal S₆₁ forms a gate pulse PU₆₁ as time changes. Similarly, the signal S₆₂ comprises a gate pulse PU₆₂ and the specific pulse PU₂₄. The gate pulse PU₆₁ and the gate pulse PU₆₂ are sequentially delivered.

Further, referring to FIG. 6A and FIG. 6B for the operation mechanism of the pixel 600, the switch SW₆₄ conducts the first end and the second end thereof according to the gate pulse PU₆₁. In the meantime, the liquid crystal capacitor C_{LC61} loads a source voltage VS₆₁ from the data line DL₆₁. The source voltage VS₆₁ is also stored in the storage capacitor C_{ST61}. Similar to the above, the switch SW₆₁ also conducts the first end and the second end thereof according to the gate pulse PU₆₁. Accordingly, the liquid crystal capacitor C_{LC62} also loads the source voltage VS₂₁, and the storage capacitor C_{ST62} also stores the source voltage VS₂₁.

Furthermore, the switch SW₆₃ also conducts the first end and the second end thereof according to the gate pulse PU₆₁. Due to the conduction of the switch SW₆₃, the compensation capacitor C_{CN6} charges or discharges to the predetermined voltage Vₚᵣₑ₆. Then, when the switch SW₆₂ conducts the first end and the second end thereof according to the gate pulse PU₆₂, the liquid crystal capacitor C_{LC62}, the storage capacitor C_{ST62}, and the compensation capacitor C_{CN6} perform charge neutralization. As a consequence, the transmittance variations of the first sub-pixel 610 and the second sub-pixel 620 are differentiated. The pixel 600 mixes colors and/or gray levels of the sub-pixels based on the different transmittance variations of the two sub-pixels, and thereby equates the transmittance variations at a side viewing angle and at a front viewing angle.

It should be noted that, provided the pixel 600 starts gray scale switching of the image at a timing t₆, during the switching, the compensation capacitor C_{CN6} is still charging or discharging to the predetermined voltage Vₚᵣₑ₆ based on the aforementioned waveform and then perform charge neutralization with the liquid crystal capacitor C_{LC62} and the storage capacitor C_{ST62}. In other words, no matter how many times the pixel 600 switches the gray scale of the image, the quantum of charge in the compensation capacitor C_{CN6} remains a fixed value before charge neutralization is performed. The problems of residual image and non-uniform image, resulting from an uncertain charge of the compensation capacitor, are therefore overcome.

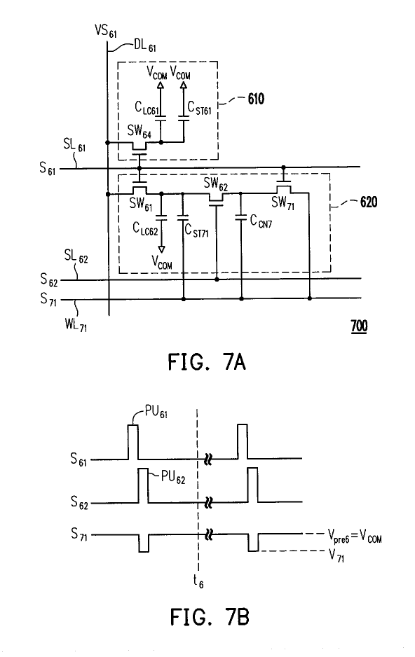

FIG. 7A is a circuit diagram of a pixel 700 according to another embodiment, and FIG. 7B is a waveform-timing diagram for illustrating the operation of the embodiment of FIG. 7A.

The main differences between the embodiments of FIGS. 7A and 7B and the embodiments of FIGS. 6A and 6B are a storage capacitor C_{ST71}, a compensation capacitor C_{CN7}, a switch SW₇₁, and a level switching line WL₇₁ of the second sub-pixel 620.

To be more specific, in the pixel 700, a first end of the storage capacitor C_{ST71} is coupled to the first end of the switch SW₆₂, and a second end of the storage capacitor C_{ST71} is coupled to the level switching line WL₇₁. A first end of the compensation capacitor C_{CN7} is coupled to the second end of the switch SW₆₂, and a second end of the compensation capacitor C_{CN7} is coupled to the level switching line WL₇₁. Moreover, a first end of the switch SW₇₁ is coupled to the first end of the compensation capacitor C_{CN7}, and a control end of the switch SW₇₁ is coupled to the scan line SL₆₁. Further, a second end of the switch SW₇₁ is coupled to the level switching line WL₇₁.

In addition, as shown in FIG. 7B, S₇₁ represents a signal transmitted via the level switching line WL₇₁, and a voltage level of the signal S₇₁ is switched from the predetermined voltage Vₚᵣₑ₆ to a compensation voltage V₇₁ according to the gate pulse PU₆₂. It is noted that the compensation voltage V₇₁ is smaller than the predetermined voltage Vₚᵣₑ₆, and the predetermined voltage Vₚᵣₑ₆ is equal to the common voltage V_{COM} of the liquid crystal display panel.

Because the voltage level of the signal S₇₁ is maintained at the predetermined voltage Vₚᵣₑ₆, when the switch SW₇₁ conducts the first end and the second end thereof according to the gate pulse PU₆₁, the compensation capacitor C_{CN7} charges or discharges to the predetermined voltage Vₚᵣₑ₆. Then, the voltage level of the signal S₇₁ is switched from the predetermined voltage Vₚᵣₑ₆ to the compensation voltage V₇, according to the gate pulse PU₆₂, so that while the switch SW₆₂ is switched according to the gate pulse PU₆₂, the feed-through voltages formed from the switch SW₆₂ to the storage capacitor C_{ST71} and the compensation capacitor C_{CN7} may be neutralized. Thus, the charges in the compensation capacitor C_{CN7} and the storage capacitor C_{ST71} are not changed when the switch SW₆₂ functions. Problems such as non-uniform image or flicker are therefore reduced.

Furthermore, similar to the embodiments of FIGS. 6a-6B, the liquid crystal capacitor C_{LC62}, the storage capacitor C_{ST71}, and the compensation capacitor C_{CN7} perform the charge neutralization due to the conduction of the switch SW₆₂. As mentioned above, the quantum of charge of the compensation capacitor C_{CN7} is maintained at a fixed value before charge neutralization is performed. Hence, the pixel 700 mixes colors and/or gray levels of the sub-pixels based on the different transmittance variations of the two sub-pixels, and thereby equates the transmittance variations at a side viewing angle and at a front viewing angle.

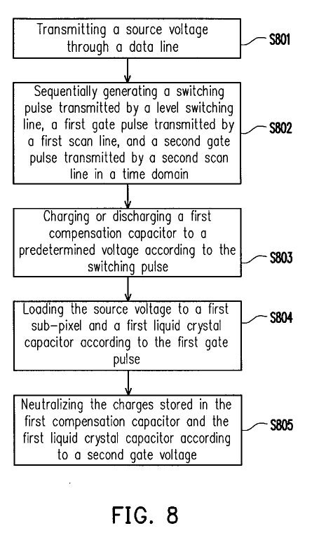

FIG. 8 is a flowchart illustrating a driving method of a liquid crystal display panel according to an embodiment. Referring to FIG. 8, the driving method of liquid crystal display panel in this embodiment comprises the following steps. First, a source voltage is transmitted through a data line (Step S801). Then, in Step S802, a switching pulse transmitted via a level switching line, a first gate pulse transmitted via a first scan line, and a second gate pulse transmitted via a second scan line are sequentially generated.

Next, in Step S803, a first compensation capacitor is charged or discharged to a predetermined voltage according to the switching pulse. Thereafter, in Step S804, the source voltage is loaded to a first sub-pixel and a first liquid crystal capacitor according to the first gate pulse. Finally, in Step S805, the charges stored in the first compensation capacitor and the first liquid crystal capacitor are neutralized according to a second gate voltage.

In this embodiment, Step S805, in which the first compensation capacitor is charged or discharged to the predetermined voltage according to the switching pulse, further comprises the following steps. First, a specific pulse is transmitted through the second scan line. Then, the specific pulse is loaded to the first compensation capacitor according to the switching pulse, wherein a voltage level of the specific pulse is maintained at the predetermined voltage.

The foregoing driving method corresponds to the embodiments discussed with respect to FIGS. 2A-5B. Another driving method corresponding to the embodiments discussed with respect to FIGS. 6A-7B will be further provided in the following paragraphs.

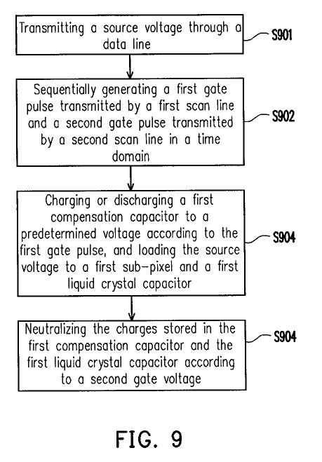

FIG. 9 is a flowchart illustrating a driving method of a liquid crystal display panel according to another embodiment. First, a source voltage is transmitted through a data line (Step S901). Next, in Step S902, a first gate pulse transmitted via a first scan line and a second gate pulse transmitted via a second scan line are generated sequentially.

Further, in Step S903, a first compensation capacitor is charged or discharged to a predetermined voltage according to the first gate pulse, and the source voltage is loaded to a first sub-pixel and a first liquid crystal capacitor. Finally, in Step S904, the charges stored in the first compensation capacitor and the first liquid crystal capacitor are neutralized according to a second gate voltage.

It should be noted that the aforementioned predetermined voltage is equal to the common voltage of the liquid crystal display panel in some embodiments, and the predetermined voltage may be varied in other embodiments to certain requirements.

In one or more embodiments, the charge neutralization is performed by the compensation capacitor and the storage capacitor to equate the transmittance variations at a side viewing angle and at a front viewing angle. Moreover, the quantum of charge of the compensation capacitor is maintained at a fixed value before the charge neutralization is performed. Thus, the problems of residual image and non-uniform image caused by the uncertain charge of the compensation capacitor can be solved.

What is claimed is:

1. A liquid crystal display panel comprising a plurality of pixels each comprising:
a first sub-pixel, coupled to a data line and a first scan line, for receiving a source voltage transmitted via the data line according to a first gate pulse transmitted via the first scan line; and
a second sub-pixel, coupled at least to the data line, the first scan line, and a second scan line for receiving the source voltage according to the first gate pulse, wherein the second sub-pixel comprises:
a first liquid crystal capacitor, for loading the source voltage; and
a first compensation capacitor coupled to be charged or discharged to a predetermined voltage before performing charge neutralization with the first liquid crystal capacitor according to a second gate pulse transmitted via the second scan line.

2. The liquid crystal display panel as claimed in claim 1, wherein the second sub-pixel is further coupled to a level switching line and the first compensation capacitor is coupled to be charged or discharged to the predetermined voltage according to a switching pulse transmitted via the level switching line.

3. The liquid crystal display panel as claimed in claim 2, wherein the second sub-pixel further comprises:
a switch which is coupled between the first compensation capacitor and a source of the predetermined voltage, and has a control terminal coupled to the level switching line for connecting the first compensation capacitor to the source of the predetermined voltage in response to the switching pulse transmitted via the level switching line.

4. The liquid crystal display panel as claimed in claim 3, wherein the source of the predetermined voltage comprises a specific pulse transmitted via the second scan line prior to the second gate pulse.

5. The liquid crystal display panel as claimed in claim 3, wherein the source of the predetermined voltage comprises a constant voltage source.

6. The liquid crystal display panel as claimed in claim 2, wherein the second sub-pixel further comprises:
a first switch, having a first end coupled to the data line, a second end coupled to a first end of the first liquid crystal capacitor, and a control end coupled to the first scan line, wherein the first end and the second end of the first switch are connected in response to the first gate pulse;
a second switch, having a first end coupled to the first end of the first liquid crystal capacitor, a second end coupled to a first end of the first compensation capacitor, and a control end coupled to the second scan line, wherein the first end and the second end of the second switch are connected in response to the second gate pulse;
a third switch, having a first end coupled to the first end of the first compensation capacitor, a second end coupled to the second scan line, and a control end coupled to the level switching line, wherein the first end and the second end of the third switch are connected in response to the switching pulse, so as to load a specific pulse of the predetermined voltage from the second scan line into the first compensation capacitor.

7. The liquid crystal display panel as claimed in claim 6, wherein the second sub-pixel further comprises:
a first storage capacitor having a first end connected to the first end of the first liquid crystal capacitor,
wherein a second end of the first liquid storage capacitor and a second end of the first compensation capacitor are commonly coupled.

8. The liquid crystal display panel as claimed in claim 7, wherein the second ends of the first liquid storage capacitor and the first compensation capacitor are commonly coupled to a common voltage of the liquid crystal display panel.

9. The liquid crystal display panel as claimed in claim 7, wherein the second ends of the first liquid storage capacitor and the first compensation capacitor are commonly coupled to the second scan line.

10. The liquid crystal display panel as claimed in claim 6, wherein the second sub-pixel further comprises:
a second compensation capacitor having a first end coupled to the first end of the first compensation capacitor and a second end coupled to a level complementary line,
wherein a second end of the first compensation capacitor is coupled to the level switching line.

11. The liquid crystal display panel as claimed in claim 10, wherein,
a signal transmitted via the level complementary line is a reverse of a signal transmitted via the level switching line; and
the second sub-pixel further comprises a first storage capacitor connected in parallel to the first liquid crystal capacitor, wherein a second end of the first liquid crystal capacitor is coupled to a common voltage of the liquid crystal display panel.

12. The liquid crystal display panel as claimed in claim 1, wherein the predetermined voltage is equal to a common voltage of the liquid crystal display panel.

13. A liquid crystal display comprising the liquid crystal display panel as claimed in claim 1.

14. The liquid crystal display panel as claimed in claim 1, wherein:
the first compensation capacitor is coupled to be charged or discharged to the predetermined voltage according to the first gate pulse.

15. The liquid crystal display panel as claimed in claim 14, wherein the second sub-pixel further comprises:
a switch which is coupled between the first compensation capacitor and a source of the predetermined voltage, and has a control terminal coupled to the first scan line for connecting the first compensation capacitor to the source of the predetermined voltage in response to the first gate pulse transmitted via the first scan line.

16. The liquid crystal display panel as claimed in claim 15, wherein the second sub-pixel further comprises:
a first switch, having a first end coupled to the data line, a second end coupled to a first end of the first liquid crystal capacitor, and a control end coupled to the first scan line, wherein the first end and the second end of the first switch are connected in response to the first gate pulse;
a second switch, having a first end coupled to the first end of the first liquid crystal capacitor, a second end coupled to a first end of the first compensation capacitor, and a control end coupled to the second scan line, wherein the first end and the second end of the second switch are connected in response to the second gate pulse;
a third switch, having a first end coupled to the first end of the first compensation capacitor, a second end coupled to the predetermined voltage, and a control end coupled to the first scan line, wherein the first end and the second end of the third switch are connected in response to the first gate pulse; and
a first storage capacitor having a first end connected to the first end of the first liquid crystal capacitor, wherein a second end of the first storage capacitor and a second end of the first compensation capacitor are commonly coupled.

17. The liquid crystal display panel as claimed in claim 16, wherein:
the second end of the third switch is coupled to a level switching line, and
a voltage level of a signal transmitted via the level switching line is switched from the predetermined voltage to a compensation voltage according to the second gate pulse, and the compensation voltage is smaller than the predetermined voltage.

18. A method of driving a liquid crystal display panel, wherein the liquid crystal display panel comprises a plurality of pixels each comprising a first sub-pixel and a second sub-pixel, wherein the second sub-pixel comprises a first liquid crystal capacitor and a first compensation capacitor, the first sub-pixel is coupled to a data line and a first scan line, the second sub-pixel is coupled at least to the data line, the first scan line, and a second scan line, said method comprising:
transmitting a source voltage through the data line to be loaded into the first and second sub-pixels in response to a first gate pulse transmitted via the first scan line, and a second gate pulse transmitted via the second scan line, respectively;
charging or discharging the first compensation capacitor to a predetermined voltage; and
after the first compensation capacitor has been charged or discharged to the predetermined voltage, neutralizing charges stored in the first compensation capacitor and the first liquid crystal capacitor according to the second gate pulse.

19. The method as claimed in claim 18, wherein the second sub-pixel is further coupled to a level switching line and the first compensation capacitor is charged or discharged to the predetermined voltage according to a switching pulse transmitted via the level switching line.

20. The method as claimed in claim 18, wherein the first compensation capacitor is charged or discharged to the predetermined voltage according to the first gate pulse.
